(19) United States
(12) Patent Application Publication
(10) Pub. No.: US 2004/0126647 A1
(43) Pub. Date: Jul. 1, 2004

(54) Heated battery cell catalyst

(76) Inventor: William E. M. Jones, Freeport (BS)

Correspondence Address: SYNNESTVEDT & LECHNER, LLP, 2600 ARAMARK TOWER, 1101 MARKET STREET, PHILADELPHIA, PA, 191072950

(21) Appl. No.: 10/699,596

(22) Filed: Oct. 30, 2003

Related U.S. Application Data
(60) Provisional application No. 60/422,434, filed on Oct. 30, 2002.

(51) Int. Cl. H01M 10/52; H01M 10/50; H01M 10/44

(52) U.S. Cl. 429/57; 429/120; 429/50

(57) ABSTRACT

A device and method for promoting the recombination of oxygen and hydrogen in a battery cell. The device, in one form, provides catalyst and heater for heating the catalyst to prevent the liquid water from interfering with the recombination reaction. In another form the device takes the form of a catalyst container having a heater inside of the container.

### RELATED APPLICATION

This application is based on and claims the benefit of U.S. Provisional Application No. 60/422,434, filed Oct. 30, 2002, and which is hereby incorporated by reference herein.

### FIELD OF THE INVENTION

The present invention is related to battery cells, and more particularly to catalysts for use in electrical battery cells to promote recombination of hydrogen and oxygen gases produced by electrolysis during battery charging.

### BACKGROUND OF THE INVENTION

The use of catalysts in batteries is believed to have been first proposed by Thomas Edison in 1913. In this application, a hot platinum wire was connected to the poles of a nickel-iron cell to recombine oxygen and hydrogen gasses (oxy-hydrogen) inside the cell. The aim was to reduce the chore of battery watering, an aim that is still valid today.

Many different catalyst devices have since been used on battery cells, most based on precious-metals of the platinum group (e.g., platinum, palladium, rhodium, etc.). To minimize cost, the precious-metal is generally used as a thin coating on base materials such as activated charcoal or alumina which have very large surface areas.

Deep cycle cells, such as those found on fork lift trucks, usually require watering every week or two which implies that they produce a large amount of oxy-hydrogen gas. Standby cells in float applications, on the other hand, may last several years without watering and produce very little oxy-hydrogen gas. Catalysts have been applied to both these types of cells but with limited success because of two major and fundamental problems, as follows:

1. Wetting problem. A battery catalyst in operation produces water vapor. If for any reason the water vapor condenses on the catalyst material itself, it can halt the recombination reaction indefinitely. The catalyst material can be recovered by drying, but this is not a practical option and, for best performance, catalysts should be kept relatively dry at all times. However, this is an extraordinarily difficult goal to achieve in practice and no satisfactory solution to this problem has been proposed to date.

2. Poisoning problem (lead acid cells). During the charging process, lead acid cells may produce secondary gasses which can poison precious metal catalyst materials by depositing coatings that block the access of the oxy-hydrogen gas. These gasses include stybene, arsine and hydrogen sulfide. Poison filter materials that absorb these gasses are available but while they may be used in the present invention, they offer only a limited solution because the filters are consumed with use. Surprisingly, in automobile exhaust systems, where catalysts are also used in the presence of catalyst poisons, poison filters are not required. This is because the high temperatures reached in exhaust systems burn off the offending deposits, thus keeping-the catalyst material- active. But while this solution is well applied in exhaust systems, no similar solution has ever been applied to batteries.

### SUMMARY OF THE INVENTION

The present invention solves these problems by heating the catalyst, preferably with an electric current. Inactivation due to self-wetting is overcome because heating keeps the catalyst material relatively dry. Catalyst poisoning is overcome by the use of high temperatures to burn off the catalyst poisons.

In one form, the present inventions provides a battery cell having a housing, a positive electrode positioned in the housing, a negative electrode positioned in the housing in spaced relationship from the positive electrode, and an electrolyte, in the housing in contact with the positive and negative electrode. In a gas space, oxygen and hydrogen gasses generated by electrolysis collect. A catalyst, in, gas communication with the gas space, converts the oxygen and hydrogen gasses to water vapor. A heater element is positioned to heat the catalyst.

In one preferred form the catalyst container is porous, preferably made of ceramic or plastic as is known in the art, and forms a reaction chamber in which the catalyst, such as palladium-coated ceramic pellets, sits. This container may have on its outer surface a water repellent coating or film layer such as PTFE. The heater can be sealed inside the catalyst container and be formed as an electrically heated resistor. The electrical wires from the heater are connected to a power source outside the cell that controls the degree of heat and the timing of the heating cycle according to a predetermined program. The heater may, for example, be operated intermittently at a low heat level for normal use but with occasional high heat settings to clean the catalyst material.

In another embodiment of the present invention, the catalyst is formed as a catalyst-plated wire, such as a palladium-plated wire. The wire, which here is included with the catalyst, is located inside a porous catalyst container, preferably ceramic, and heated to a suitably high temperature whenever the battery is in a gassing phase of recharge. In addition, from time to time, the temperature may be raised higher to burn off any catalyst poisons that may have coated the wire. A variation of this embodiment is that a non-precious metal wire may be used. That is, hot wires made from non-precious metals can recombine oxy-hydrogen satisfactorily, but at higher temperatures, so the risk of explosions must be minimized by the careful use of the porous reaction chamber.

In one preferred form of the invention using an electric resistance heater, the heating current is supplied from a source external to the cells. For example, in a string of battery cells, each cell has its own heated catalyst connected by electrical leads to a common power supply and control source so that all catalyst heaters are operated in coordination. The power source may be a tap on the battery itself or, generally, any alternating or direct current power supply.

The present invention also provides a catalyst device for use with a battery cell and includes a gas-permeable catalyst container which has a container of a flame arresting material having pores of suitable size to permit oxygen and hydrogen gasses to pass there through while being a barrier to a flame. The container also has a reaction chamber within the container. A catalyst for reacting the hydrogen and, oxygen gasses to water vapor is positioned within the reaction chamber. A heater element is disposed to provide heat to the catalyst and thereby dry the catalyst of any water liquid.

The present invention also provides a method of reducing water loss in a battery cell while keeping the catalyst dry and poison free.

### BRIEF DESCRIPTION OF THE DRAWINGS

The foregoing summary, as well as the following detailed description will be better understood when read in conjunction with the figures appended hereto. For the purpose of illustrating the invention, there is shown in the drawings several a preferred embodiments. It is understood, however, that this invention is not limited to the precise arrangement and instrumentalities shown.

FIG. 1 is a sectional view of an electrical battery cell with a heated catalyst device according to the invention;

FIG. 2 is a detailed sectional view of a heated catalyst device on an enlarged scale;

FIG. 2A is a sectional view of an alternate embodiment of a heated catalyst device;

FIG. 3 is a sectional view of another alternate embodiment of a heated catalyst device; and

FIG. 4 is a sectional view of still another alternate embodiment of a heated catalyst device.

### DETAILED DESCRIPTION OF THE PRESENTLY PREFERRED EMBODIMENTS

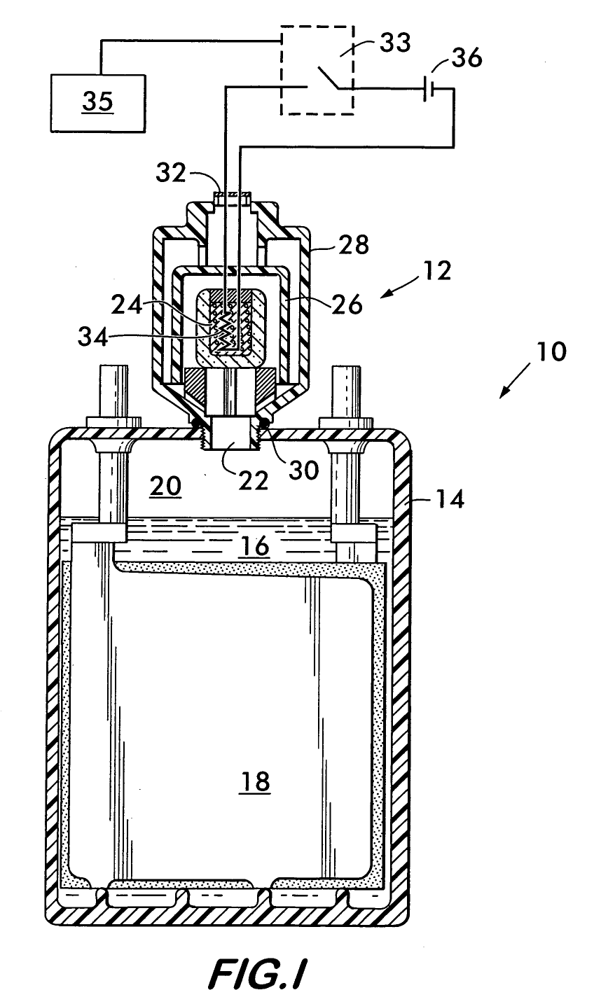

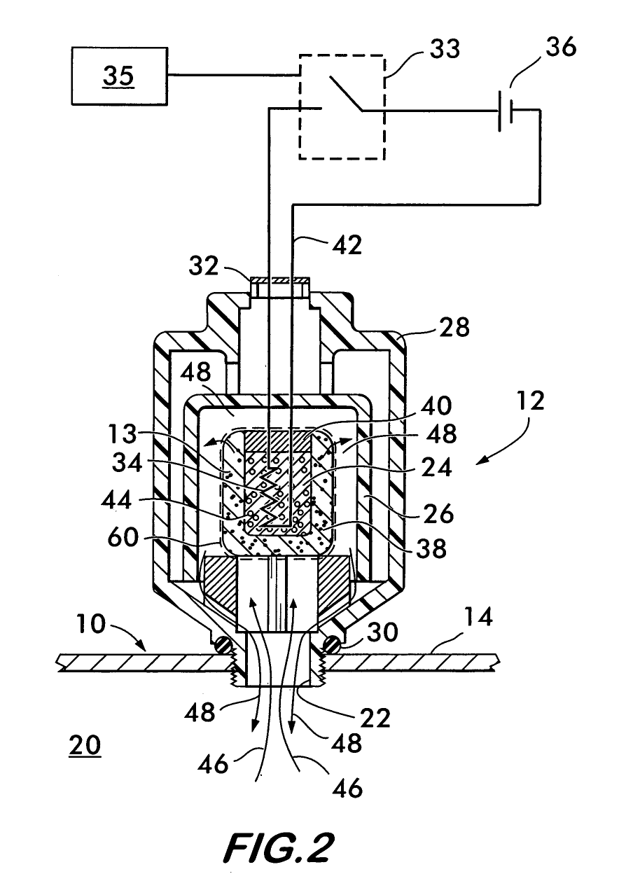

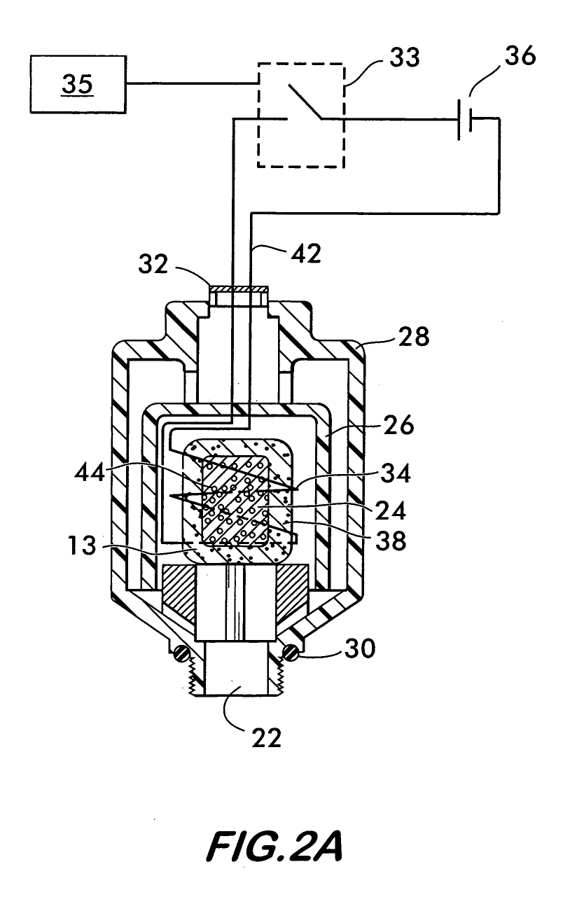

Referring now to the drawings in detail, wherein like numerals indicate like elements throughout the several views, shown in FIGS. 1 and 2 is a battery cell 10 having a heated catalyst device 12 according to the present invention. Battery cell 10 comprises a housing 14 (the battery cell container) holding an electrolyte solution 16. Immersed in the electrolyte 16 are positive and negative plates 18 spaced from one another and separated by a separator, such as a glass mat (usually plastic in flooded cells) as is know in the art. Battery cell 10 has an aqueous electrolyte 16 and could, for example, be a nickel-cadmium cell or a lead-acid type cell. Oxygen and hydrogen gases are produced during charging as a result of electrolysis of the water in the electrolyte 16. The gases accumulate in a gas space 20 above the plates 18 and the electrolyte 16. The electrolysis causes a loss of water from the electrolyte solution 16, and as a result, such battery cells require periodic replenishment of the lost water.

The need for periodic water replenishment is reduced by the use of the catalyst device 12 to recombine the hydrogen and oxygen gases into Water and return the water to the cell 10. Catalyst device 12, preferably mounted on the cell housing 14, is in fluid communication with the gas space 20 through a channel 22. The catalyst deice 12 is formed as a cylindrical catalyst container 13 having walls 38 defining an internal reaction chamber 24.

A catalyst 44 for reacting the hydrogen and oxygen gasses to form water vapor is arranged in the reaction chamber 24. Hydrogen and oxygen gases from the gas space 20 flow through the channel 22 and into a reaction chamber 24 where the gases are recombined at a controlled rate to produce water. Water in the gaseous state leaves the reaction chamber 24 and encounters a condensation surface 26 on which the water vapor condenses and is then permitted to drain back into the cell 10 through the channel 22. An outer casing 28 cooperates with a seal 30 to keep the gases flowing from the gas space to the reaction chamber 24, and the water flowing from the condensation surface to the cell 10. The outer casing 28 is vented to atmosphere by a vent 32 to release excess accumulation of oxygen and hydrogen gases. Although the condensation surface 26 is shown as separate from the outer casing 26, the outer casing could also comprise the condensation surface 26. Many of the features of the illustrated container 13 are similar to those disclosed in U.S. Pat. No. 4,002,496 the disclosure of which is incorporated herein by reference.

As shown in more detail in FIG. 2, the catalyst container 13 of the present embodiment is gas permeable to allow the gasses to pass through to the catalyst within and formed to be flame arresting. It has a side wall 38 preferably made of a porous ceramic such as alumina (Al₂O₃) or silicon carbide (SiC) to withstand the relatively high temperatures occasioned by the heat generated when hydrogen and oxygen recombine within the reaction chamber 24. Porous polytetrafluoroethylene is also feasible. As is well known, the pore size of the porous sidewall should preferably be less than about 0.010 inches to allow adequate diffusion of the hydrogen and oxygen through the sidewall while preventing any flame or explosion from passing through.

The catalyst 44 in the reaction chamber 24 promotes the recombination of the hydrogen and oxygen. Preferred catalysts include carbon or alumina pellets coated with platinum, palladium, rhodium or other metals in the platinum group. Porous pellets-are preferred because they provide a large catalytic surface area on which the hydrogen-oxygen reactions may take place.

A heater 34 is provided for heating the catalyst 44. In the preferred embodiment, the heater 34 takes the form of a resistive heating element coupled to a power source such as a battery 36, which is preferably the battery of which the cell 10 on which the catalyst device 12 is mounted is a part but can be, generally, any ac or dc electrical source. A switch 33, preferably under the command of a controller 35 is used to control power to the heating element 34 and turn it on and off as appropriate.

The heat provided by the heater 34 comes from an external source, e.g., electricity, and is not the heat from the recombination reaction of the oxygen and hydrogen. Furthermore, the external heat source, e.g., if electricity, preferably comes from outside the cell 10, such as from the battery of which the cell 10 is apart, or some other source.

The container 13 has a one sealed end 40 through which electrical leads 42 extend to the power source 36. End 40 is sealed, after addition of the catalyst and heating element, preferably with a resin such as epoxy which adheres closely to the electrical leads and does not allow an escape path for hydrogen to form along the leads.

Heating element 34 is preferably an electrical resistance heater placed in proximity to the catalyst pellets 44 to encourage heat transfer. Where a conductive catalyst material 44 may be in contact with the heating element 34, the heating element may be insulated to prevent the catalyst 44 from shorting out the element. Heating element 34 preferably comprises a Nichrome wire with a ceramic, epoxy or PTFE insulating layer. The heating element 34 is used to keep the catalyst 44 dry, as explained below, and preferably is heated to a temperature of about 100° F. to drive any liquid water out of the reaction chamber 24. It is appreciated the invention is not limited to the 100° F. example as any suitable temperature can be used.

Alternately, as shown in FIG. 2A, the heating element may be wrapped around the outside sidewall 38 of reaction chamber 24 or otherwise in contact with the sidewall to heat the catalyst 44 there within. Many other ways of transferring heat from the heater to the catalyst material by conduction, convection and radiation will be apparent to those skilled in the art.

In operation, as depicted in FIG. 2, hydrogen and oxygen gases represented by arrows 46 in the gas space 20 of the cell 10 travel up channel 22 and diffuse through porous sidewall 38 into reaction chamber 24. The gases 46 encounter the catalyst 44 and recombine into water represented by arrows 48. Due to the exothermic nature of the reaction, the water 48 is in the vapor state and diffuses out through the porous sidewall 38 where it condenses to a liquid on the condensation surface 26 and drains back into the cell 10 through the channel 22.

There are times, however, when the water vapor 48 in the reaction chamber 24 condenses on the catalyst 44, fouling the catalytic surface and substantially halting the recombination of hydrogen and oxygen. This problem may occur when the charging is suddenly switched off so that the exothermic reaction of hydrogen recombining with oxygen stops. The problem is especially acute when the catalyst is relatively cold, due, for example, to a cold environment. The cold may cause any water vapor within reaction chamber 24 to condense on the catalyst and wet it. To be effective, the catalyst must be kept dry, and if it becomes wet, it must be dried quickly. The heating element 34 serves this function. The heating element 34 preferably runs at or above about 100° F., but could also run in excess of 100° C. (the temperature of boiling water) and will dry the catalyst 44 quickly and permit the oxygen-hydrogen recombination reaction to take place. Once underway, the reaction is self-sustaining in that the heat energy liberated as a result of the exothermic reaction will keep the catalyst dry, thus, the heating element 34 may be turned off by controller 35 using switch 33. However, if the catalyst is initially wet, the exothermic reaction will not start in the absence of the forced heating provided by the present invention.

The catalyst container 13 can have a gas-permeable hydrophobic coating 60 to prevent water/electrolyte from entering the catalyst container. For example, such a coating could be formed by a polytetrafluoroethylene (PTFE) film wrapped around the container 13. Suitable PTFE films include seal tapes of the type having a military specification of 3 mils thickness, 0.9 g/cc density, 70% elongation; another being a commercial grade of 2.0 mils thickness, 0.22 micron pore size. These tapes are self-adhering to form a liquid tight barrier.

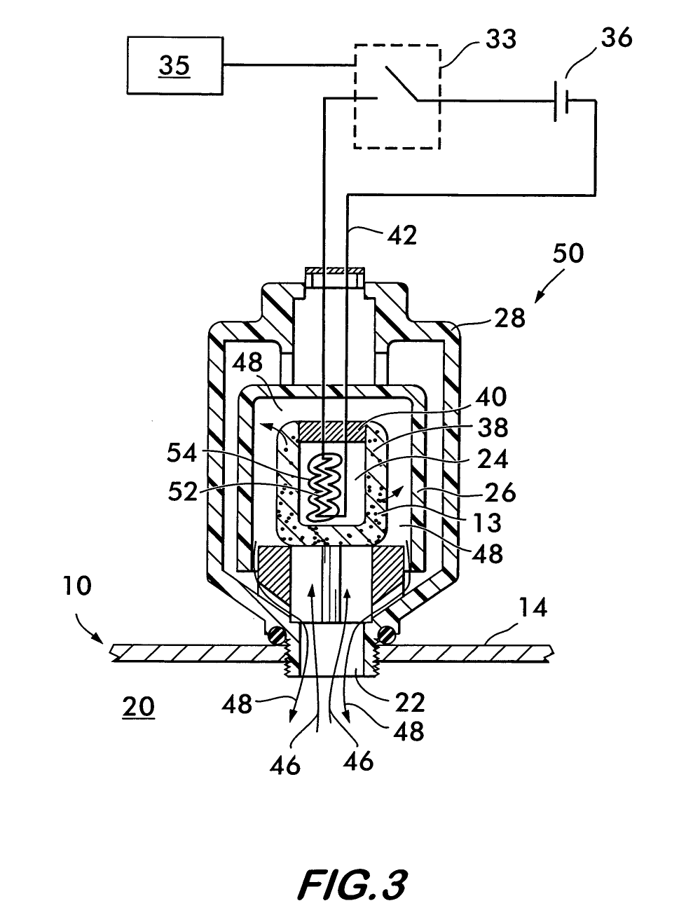

FIG. 3 shows another preferred embodiment of a catalyst device 50 according to the invention. The reaction chamber 24 is again defined by a catalyst container 13 having a porous sidewall 38 with a sealed end 40 through which electrical leads 42 extend. Reaction chamber 24 contains a heating element 52 which is coated with a catalyst 54. Preferably, the heating element is an electrically resistive element such as a nichrome wire and the catalyst is a metal such as platinum, palladium or other member of the platinum group of noble metals coated onto the nichrome by, for example, vapor deposition, sputter deposition or electroplating.

In operation, the heating element 52 is preferably maintained at temperatures above 100° F.; the higher the temperature, the faster is the recombination reaction. Hydrogen and oxygen gases 46 from the gas space 20 which diffuse through the porous sidewall 38 contact the hot catalyst 54 and recombine to form water 48, which diffuses out through the porous sidewall 38, condenses on the condensing surface 26 and drains back into the cell through channel 22.

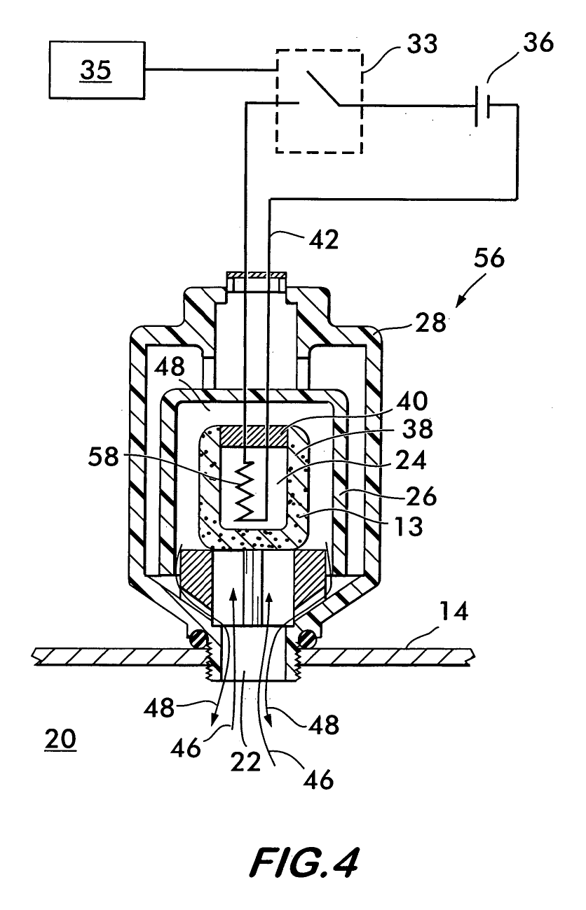

FIG. 4 illustrates another preferred embodiment of the catalyst device 56 according to the invention. Catalyst device 56 also comprises a catalyst container 13 having a porous sidewall 38 with a sealed end, 40 and defining a reaction chamber 24. Electrical leads 42 which pass through sealed end 40 connect to a heating element 58, preferably comprising a resistive element such as stainless steel or nichrome wire either bare or coated in a protective insulator such as enamel. The heating element 58 itself promotes the recombination of hydrogen and oxygen gases. Since there is no chemical catalyst such as platinum, it is preferred to maintain the heating element 58 at a temperature above about 200° F. to promote the recombination of hydrogen and oxygen gases 46 which diffuse into the reaction chamber from the gas space 20 of the cell 10. The higher the temperature, the more rapid the recombination reaction so the optimum temperature will depend on the application. Similar to the previous embodiments, the water 48 formed by the reaction condenses on the condensing surface 26 and drains back into the cell 10 through channel 22.

Features of the various embodiments of the catalyst device according to the invention may be used with catalytic devices such as disclosed in U.S. Pat. Nos. 4,002,496 to Nitta et al and 4,048,387 to Lahme et al, both of these patents being hereby incorporated by reference. The invention is also believed applicable for incorporation in catalyst devices of the type used with VRLA cells (valve regulated lead acid cells) such as those disclosed in U.S. patent application Ser. Nos. 09/461,552, filed 14 Dec. 1999, and 09/022,336 filed 11 Feb. 1998 and U.S., the disclosure of which are also hereby incorporated by reference herein.

For example, U.S. patent application Ser. No. 09/461,552, filed 14 Dec. 1999 discloses a catalyst container made of a high temperature plastic such as Questra made by Dow Chemical. This container is impermeable to fluids and gasses, but has an opening at one end which is sealed with a porous member to allow the oxygen and hydrogen gasses to pass through to the catalyst within, but which is configured to prevent a flame from passing through. The porous member can be made of PVDF (polyvinylidene fluoride), PTFE, or polypropylene and which is also preferably hydrophobic. It is conceived that a heater of the type described above could be added to the interior of a similar catalyst container.

It is understood that the foregoing description is intended to describe the preferred embodiments of the present invention and is not intended to limit the invention in any way. This invention is to be read as limited only by the appended claims.

In the claims:

1. A battery cell, comprising:
a housing;
a positive electrode positioned in the housing;
a negative electrode positioned in the casing in spaced relationship from the positive electrode;
an electrolyte in the casing in contact with the positive and negative electrodes;
a gas space where oxygen and hydrogen gasses collect;
a catalyst for converting said oxygen and hydrogen gasses to water vapor, said catalyst being in gas communication with said gas space; and
a heater element disposed to heat said catalyst.

2. The battery cell of claim 1 further comprising a gas-permeable catalyst container in gas communication with the gas space so as to be capable of receiving said hydrogen and oxygen gasses from said cell, said container comprising a flame arresting material having pores of suitable size to permit said oxygen and hydrogen to pass there through while being a barrier to a flame, said container further defining a reaction chamber within said container and in which said catalyst is disposed.

3. The battery cell of claim 2 wherein said heater element comprises an electric heater element.

4. The battery cell of claim 2 wherein heater element is disposed within said container.

5. The battery cell of claim 2 wherein heater element is disposed outside said container.

6. The battery cell of claim 2 wherein said heater element comprises a resistance wire.

7. The battery cell of claim 2 wherein said heater element comprises a wire, said wire being electrically insulated.

8. The battery cell of claim 1 wherein said heater element comprises an electric resistive element, and said catalyst is attached to said heater element.

9. The battery cell of claim 2 further comprising a gas-permeable hydrophobic layer around said container.

10. A battery cell in accordance with claim 1 wherein said catalyst container is mounted on top of said housing.

11. A battery cell in accordance with claim 1 wherein said catalyst container is mounted outside of said housing.

12. A catalyst device for use with a battery cell and capable of being placed in gas communication with oxygen and hydrogen gasses formed within cell; said device, comprising:
a gas-permeable catalyst container, said container comprising a flame arresting material having pores of suitable size to permit said oxygen and hydrogen gasses to pass there through while being a barrier to a flame, said container having a reaction chamber within said container;
a catalyst for reacting said hydrogen and oxygen gasses to water vapor, said catalyst positioned within said reaction chamber; and
a heater element disposed to provide heat to said catalyst and thereby dry said catalyst of any water liquid.

13. The catalyst device of claim 12 wherein said heater element comprises an electric heater element.

14. The catalyst device of claim 13 wherein the heater element is disposed within said catalyst container.

15. The catalyst device of claim 14 wherein the heater element is disposed on an outside wall of said catalyst container.

16. The catalyst device of claim 13 wherein said heater element comprises a resistance wire.

17. The catalyst device of claim 13 wherein said heating element comprises a wire, said wire being electrically insulated.

18. The catalyst device of claim 13 wherein said heater element comprises an electric resistive element, said catalyst being a coating on said heating element.

19. The catalyst device of claim 13 further comprising a gas-permeable hydrophobic layer around said container.

20. The catalyst device of claim 19 wherein said a gas-permeable hydrophobic layer comprises PTFE.

21. A device for use with a battery cell and capable of being placed in gas communication with oxygen and hydrogen gasses formed within cell; said device comprising:
a gas-permeable container, said container comprising a flame arresting material having pores of suitable size to permit said oxygen and hydrogen gasses to pass there through while being a barrier to a flame, said container having a reaction chamber within said container; and
a heater element for reacting said hydrogen and oxygen gasses to water vapor, said heater element positioned within said reaction chamber.

22. A catalyst device for use with a battery cell in accordance with claim 1 further comprising a catalyst supported on said heater element.

23. A method of reducing the amount of water loss in a battery cell having a casing, an electrolyte within the casing, positive and negative electrodes in said electrolyte and spaced from one another, and a gas space where oxygen and hydrogen gasses generated within the cell collector said method comprising:
providing a gas-permeable container, said container comprising a flame arresting material having pores of suitable size to permit said oxygen and hydrogen gasses to pass there through while being a barrier to a flame, said container having a reaction chamber within said container;
allowing said oxygen and hydrogen gasses from said gas space to enter said reaction chamber wherein said oxygen and hydrogen gasses combine to form water vapor, and
providing an external source of heat to said reaction chamber.

24. The method of claim 23 further comprising a catalyst capable of reacting oxygen and hydrogen to form water vapor, said catalyst positioned within said container.

25. The method of claim 23 Wherein said source of heat is provided by a wire operating at a temperature of at least 200° F., said wire being heated by providing an electric current through said wire.

26. The method of claim 24 wherein said source of heat is provided by a wire heated by providing an electric current through said wire.

27. The method of claim 26 wherein said heat is provided intermittently to dry said catalyst.

28. The method of claim 23 wherein said source of heat is provided by a wire operating at a temperature higher than room temp, said wire being heated by providing an electric current through said wire.
